(19) United States
(12) Patent Application Publication
(10) Pub. No.: US 2008/0007153 A1
(43) Pub. Date: Jan. 10, 2008

(54) FIELD EMISSION DEVICE

(75) Inventors: YUAN-CHAO YANG, Beijing (CN); JIE TANG, Beijing (CN); LIANG LIU, Beijing (CN); SHOU-SHAN FAN, Beijing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng (TW)

(21) Appl. No.: 11/565,533

(22) Filed: Nov. 30, 2006

(30) Foreign Application Priority Data
Jul. 5, 2006 (CN) 200610061511.X

(51) Int. Cl. H01J 63/04; H01J 1/62

(52) U.S. Cl. 313/496

(57) ABSTRACT

A field emission device (10) includes a sealed container (12) with a first light-permeable portion (120) and an opposite second light-permeable portion (122). A first phosphor layer (14) is formed on the first light-permeable portion. A first light-permeable anode (16) is formed on the first light-permeable portion. A second phosphor layer (18) is formed on the second light-permeable portion. A second light-permeable anode (20) is formed on the second light-permeable portion. A shielding barrel (22) is disposed within the container and electrically connected to at least one cathode electrode (25, 26). The shielding barrel has opposite open ends facing toward the first and the second light-permeable portions respectively. The shielding barrel has an inner surface, and a slurry layer (24) containing conductive nano material is formed on the inner surface of the shielding barrel.

### CROSS-REFERENCE TO RELATED APPLICATIONS

This application is related to commonly-assigned copending application Ser. No. ______, entitled “FIELD EMISSION DEVICE” (attorney docket number US 11269). Disclosures of the above-identified application are incorporated herein by reference.

### BACKGROUND OF THE INVENTION

1. Field of the Invention

The present invention relates to field emission devices, and more particularly to a field emission device.

2. Description of Related Art

Field emission devices are based on emission of electrons in a vacuum. Electrons are emitted from micron-sized tips in a strong electric field, and the electrons are accelerated and collide with a fluorescent material. The fluorescent material then emits visible light. Field emission devices are thin, light weight, and provide high levels of brightness.

Conventionally, a material of the tips is selected from the group consisting of molybdenum (Mo) and silicon (Si). With the development of nano-technology, carbon nanotube (CNT) is also used in the tips of the field emission devices. However, the typical working voltage of such field emission devices is about 10,000 volts, which can easily generate enough static force to break the CNTs. As a result, performance of these field emission devices is unstable.

What is needed, therefore, is a field emission device capable of stable operation.

### SUMMARY OF THE INVENTION

A field emission device includes a sealed container with a first light-permeable portion and an opposite second light-permeable portion. A first phosphor layer is formed on the first light-permeable portion. A first light-permeable anode is formed on the first light-permeable portion. A second phosphor layer is formed on the second light-permeable portion. A second light-permeable anode is formed on the second light-permeable portion. A shielding barrel is disposed within the container and electrically connected to at least one cathode electrode. One end of the shielding barrel faces towards the first light-permeable portion and the other end faces towards the second light-permeable portion. The shielding barrel has an inner surface. A slurry layer containing conductive nano material is formed on the inner surface of the shielding barrel.

### BRIEF DESCRIPTION OF THE DRAWINGS

Many aspects of the present field emission device can be better understood with reference to the following drawings. The components in the drawings are not necessarily drawn to scale, the emphasis instead being placed upon clearly illustrating the principles of the present field emission device. Moreover, in the drawings like reference numerals designate corresponding parts throughout the several views.

FIG. 1 is a schematic, cross-sectional view of a filed emission device in accordance with a first embodiment.

FIG. 2 is a schematic, cross-sectional view of the filed emission device from FIG. 1 taken along the line II-II.

### DETAILED DESCRIPTION OF THE INVENTION

Reference will now be made to the drawings to describe in detail the preferred embodiment of the field emission device.

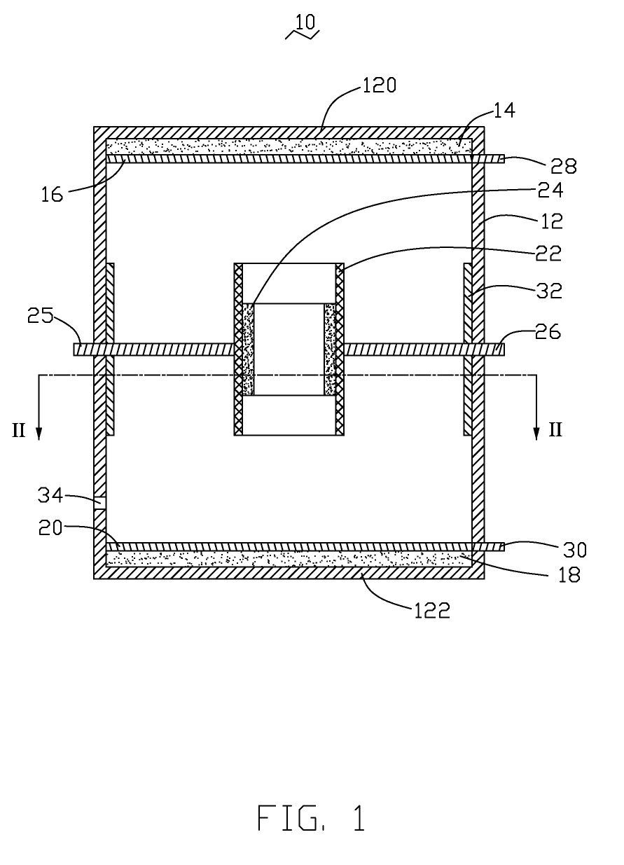

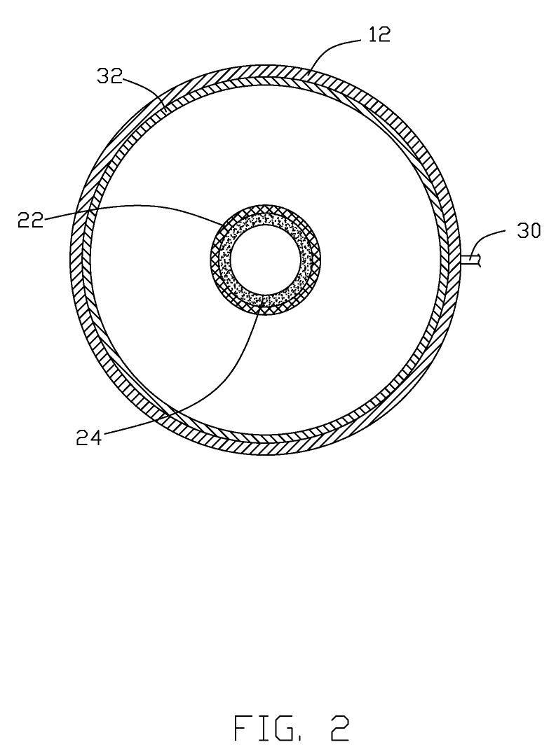

Referring to FIGS. 1 and 2, a field emission device 10 includes a first light-permeable portion 120, a second light-permeable portion 122, and a sealed container 12. The sealed container 12 encloses a first light-permeable anode 16, a second light-permeable anode 20 and a shielding barrel 22. First and second phosphor layers 14, 18 are deposited on the first and the second light-permeable portions 120, 122 respectively. The first and the second phosphor layers 14, 18 contain fluorescent material that can emit white or colored light when being bombarded with electrons. The first and the second light-permeable anodes 16, 20 are formed on the first and the second phosphor layers 14, 18 respectively. The shielding barrel 22 is disposed within the sealed container 12. The shielding barrel 22 has opposite open ends respectively facing toward the first and second light-permeable portions 120, 122. A solidified nano slurry layer 24 is formed on an inner surface of the shielding barrel 22. The shielding barrel 22 is connected with at least one cathode electrode. In the illustrated embodiment, the shielding barrel 22 is connected with two cathode electrodes 25, 26. The at least one cathode electrode 25, 26 surrounds the shielding barrel 22. The first and the second light-permeable anodes 16, 20 and the terminals are electrically connected with a first anode wire 28 and a second anode wire 30 respectively, which lead (i.e., run) from the inside to outside of the sealed container 12. The first and the second anode wire 28, 30 as well as the cathode electrodes 25, 26 are electrically connected with respective terminals for enabling application of an electric field over the shielding barrel 22 and the first and the second light-permeable anodes 16, 20.

The sealed container 12 is a hollow member that defines an inner space, the inner space being held in a vacuum. The main portion of the sealed container 12 in cross-section can be, for example, a circle, a quadrangle, a triangle, or a polygon. In the illustrated embodiment, the main portion of the sealed container is a cylinder. The first and the second light-permeable portions 120, 122 may be a planar surface, a spherical surface, or an aspherical surface, and can be selected according to application. The sealed container 12 is light-permeable, and preferably transparent. The sealed container 12 according to the embodiment can be made of a nonmetal material, for example, quartz or glass. Such materials as quartz or glass are beneficial in that they are electrically insulative.

The first and the second light-permeable anodes 16, 20 are metal films with good electric conductivity. In the preferred embodiment, the anodes 16, 20 are aluminum films. In the illustrated embodiment, the shielding barrel 22 is a cylinder with a central axis perpendicular to the first and the second light-permeable portions 120, 122. It can be understood that other shapes of the shielding barrel 22 can be selected according to the shape of the sealed container 12.

The solidified nano slurry layer 24 contains a conductive nano material. The conductive nano material is selected from the group consisting of carbon nanotubes, carbon nano-sticks, carbon nano-yarns, Buckminster-fullerenes (C60), carbon nano-particles. The conductive nano material can also be selected from the group consisting of nanotubes, nano-sticks, nano-yarns, nano-particles of conductive metal and semiconductors. In the preferred embodiment, the conductive nano material consists of carbon nanotubes. Firstly, the nano slurry is spread on the inner surface of the shielding barrel 22 and solidified. Then the slurry 24 is scrubbed with a rubber to expose ends of the carbon nano tubes so that the conductivity of the shielding barrel 22 can be enhanced. Distance between edge (e.g., top end) of the nano slurry layer 24 and edge (e.g., top end) of the shielding barrel 22 determines shielding effect of the shielding barrel 22. The distance is bigger; the effect is more apparently.

In order to maintain the vacuum of the inner space of the sealed container 12, a getter 32 may be arranged therein to absorb residual gas inside the sealed container 12. The getter 32 should preferably be arranged on an inner surface of the sealed container 12 around the electrodes 25, 26. The getter 32 may be evaporable getter introduced using high frequency heating. The getter 32 also can be non-evaporable getter. It must be ensured that the getter 32 does not attach to the light-permeable anodes 16, 20 in order to avoid short circuits between the light-permeable anode 16, 20 and the electrodes 25, 26.

The sealed container 12 further includes an air vent 34. The air vent 34 connects a vacuum pump to vacuum the sealed container 12 before packaging sealing the container.

In operation, when putting a voltage over the electrodes 25, 26 and the light-permeable anodes 16, 20, electrons will emanate from two openings of the shielding barrel 22. The electrons move towards and transmit through the first and the second light-permeable anodes 16, 20. When the electrons hit the first and second phosphor layers 14, 18 visible lights will be emitted. One part of the lights will transmit through the first and the second light-permeable portions 120, 122, and the other part of the lights will be reflected by the first and the second light-permeable anodes 16, 20, and spread out of the light-permeable portions 120, 122. A plurality of such tubes 10 can be arranged together to use for lighting and two-sided displaying. Because of the shielding effect of the shielding barrel, the field emission device can operate with greater stability at higher voltages.

While the present invention has been described as having preferred or exemplary embodiments, the embodiments can be further modified within the spirit and scope of this disclosure. This application is therefore intended to include any variations, uses, or adaptations of the embodiments using the general principles of the invention as claimed. Further, this application is intended to include such departures from the present disclosure as come within known or customary practice in the art to which the invention pertains and which fall within the limits of the appended claims or equivalents thereof.

What is claimed is:

1. A field emission device, comprising:
a sealed container with a first light-permeable portion and an opposite second light-permeable portion;
a first phosphor layer formed on the first light-permeable portion;
a first light-permeable anode formed on the first light-permeable portion;
a second phosphor layer formed on the second light-permeable portion;
a second light-permeable anode formed on the second light-permeable portion;
a shielding barrel disposed within the container and electrically connected to at least one cathode electrode, the shielding barrel having opposite open ends facing toward the first and the second light-permeable portions respectively, the shielding barrel having an inner surface; and
a slurry layer containing conductive nano material, the slurry layer being formed on the inner surface of the shielding barrel.

2. The field emission device as claimed in claim 1, wherein the sealed container is a vacuum container.

3. The field emission device as claimed in claim 1, wherein the sealed container is a hollow cylinder.

4. The field emission device as claimed in claim 1, wherein the sealed container is comprised of a material selected from the group consisting of quartz, glass and any combination thereof.

5. The field emission device as claimed in claim 1, wherein the first and the second light-permeable portion is flat, spherical, or aspherical in shape.

6. The field emission device as claimed in claim 1, wherein the first and the second light-permeable anodes are aluminum layers.

7. The field emission device as claimed in claim 1, wherein the conductive nano material is selected from the group consisting of carbon nanotubes, carbon nano-sticks, carbon nano-yarns, Buckminster-fullerene, and carbon nano-particles.

8. The field emission device as claimed in claim 1, wherein the conductive nano material is selected from the group consisting of nanotube, nano-stick, nano-yarn, nano-particle of conductive metal and semiconductor.

9. The field emission device as claimed in claim 1, further comprising a getter arranged around the at least one cathode electrode.

10. The field emission device as claimed in claim 1, wherein the at least one cathode electrode is arranged between the first and second light-permeable anode.

11. The field emission device as claimed in claim 1, wherein the at least one cathode electrode surrounds the shielding barrel.

12. The field emission device as claimed in claim 1, wherein the first phosphor layer is sandwiched between the first light-permeable portion and the first light-permeable anode.

13. The field emission device as claimed in claim 1, wherein central axis of the container is perpendicular to the first and the second light-permeable portions.

14. The field emission device as claimed in claim 1, wherein the inner surface of the shielding barrel has an intermediate region with the slurry layer provided thereon and opposite lateral bare regions free of the slurry layer provided thereon.
